(19) United States
(12) Patent Application Publication
(10) Pub. No.: US 2002/0033586 A1
(43) Pub. Date: Mar. 21, 2002

(54) Aerodynamic bicycle frame

(76) Inventors: Gerard Vroomen, Ar Heide (NL); Philip White, Toronto (CA)

Correspondence Address: DAVID R PRESTON & ASSOCIATES, 12625 HIGH BLUFF DRIVE, SUITE 205, SAN DIEGO, CA, 92130, US

(21) Appl. No.: 09/961,041

(22) Filed: Sep. 20, 2001

(30) Foreign Application Priority Data
Sep. 20, 2000 (CA) 2,319,985

(51) Int. Cl. B62M 3/00

(52) U.S. Cl. 280/274; 280/281.1

(57) ABSTRACT

An arrangement of a bicycle frame wherein the seat tube below the seat post seat tube junction, and down to the down tube-seat tube junction, is greatly curved so as to follow the curvature of the rear wheel.

### FIELD OF THE INVENTION

The invention relates to a bicycle frame comprising a partially curved seat tube, which has a constant width at the trailing edge when viewed from the rear, and which covers a substantial portion of the front and upper portion of the rear wheel, for the purpose of aerodynamically shielding the rear wheel.

In conjunction with this, the invention also incorporates an improved rear brake area that integrates the seat stays into the frame in such a manner to improve the aerodynamics of this area and includes a brake plate to which the rear brake is attached prior to its mounting to the frame. This plate permits attachment of the brake to the frame without compromising the aerodynamics, stiffness, or strength of the frame. The present invention further improves the aerodynamics by integrating the rear wheel with the frame through rearward facing adjustable dropouts that allow proper wheel to seat tube spacing, and a recessed concave trailing edge to the lower curved seat tube. Finally, the invention enhances the stability of the bike by moving the center of pressure rearward.

### BACKGROUND OF THE INVENTION

Prior art seat tubes are either straight or only have a recessed curved section and, as such, do not fully shield the rear wheel. Additionally, prior art seat tubes with a curved section cut into a predominantly straight seat tube (as shown in FIG. 1) do not have a trailing edge with a constant width as viewed from the rear (see FIG. 2): the middle is wider, and the top and bottom narrower.

As well, the prior art seat tube does not extend much over the upper portion of the rear wheel. Further, it is the upper portion of the rear wheel where aerodynamic shielding is the most useful. By not covering as much of the upper portion of the rear wheel, current bicycle frames do not achieve optimal aerodynamic shielding in this area.

### SUMMARY OF THE INVENTION

By using a seat tube of constant width at the trailing edge of the curved section, greater aerodynamic efficiency is achieved through more effective aerodynamic shielding. As well, by employing a larger curve in the seat tube, a greater portion of the rear wheel is aerodynamically shielded. This includes the upper portion of the rear wheel, where the greatest aerodynamic benefits are achieved.

### BRIEF DESCRIPTION OF THE DRAWINGS

These and other advantages of the invention will become apparent upon reading the following detailed description and upon referring to the drawings in which:

FIG. 1 (a & b) is a side view of prior art aerodynamic bicycle frames;

FIG. 2 is a rear view of the seat tube cutout of a prior art aerodynamic bicycle frame;

FIG. 3 is a rear view of the seat tube of the invention;

FIG. 4 is a cross section of the curved lower section of the invention's seat tube;

FIG. 5 is a view of the sect stay to seat tube joint and rear brake area of the invention showing the integrated splat stays and the brake plate,

FIG. 6 is a side view of the invention;

FIG. 7 is an alternative side view of the invention;

FIG. 8 is a front view of the invention;

FIG. 9 is a rear view of the invention;

FIG. 10 is a top view of the invention;

FIG. 11 is a bottom view of the invention;

FIG. 12 is a perspective view of the invention;

FIG. 13 is a view of a prior art bicycle showing the various parts;

FIG. 14 is a diagram of the invention showing the close proximity of the tire to the trailing edge of the lower curved portion of the seat tube;

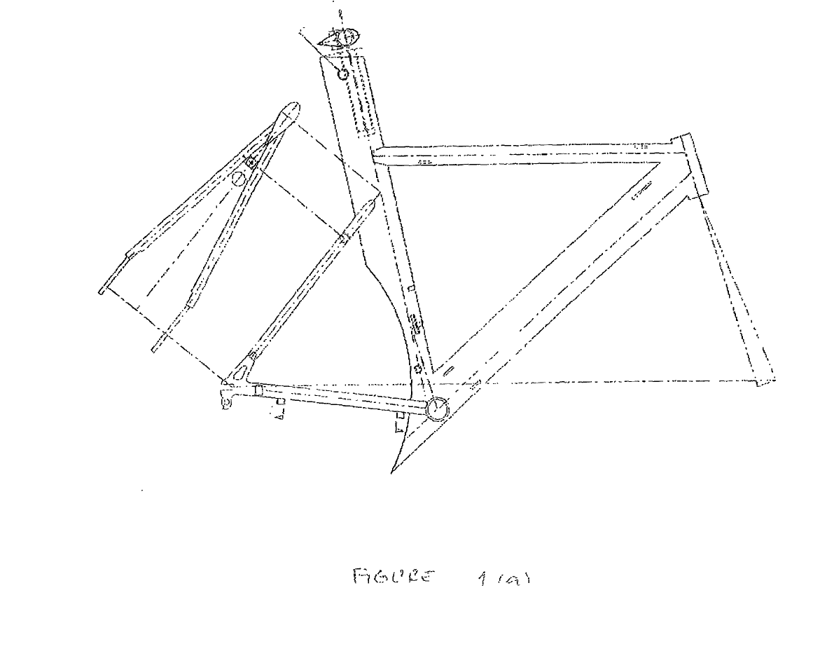

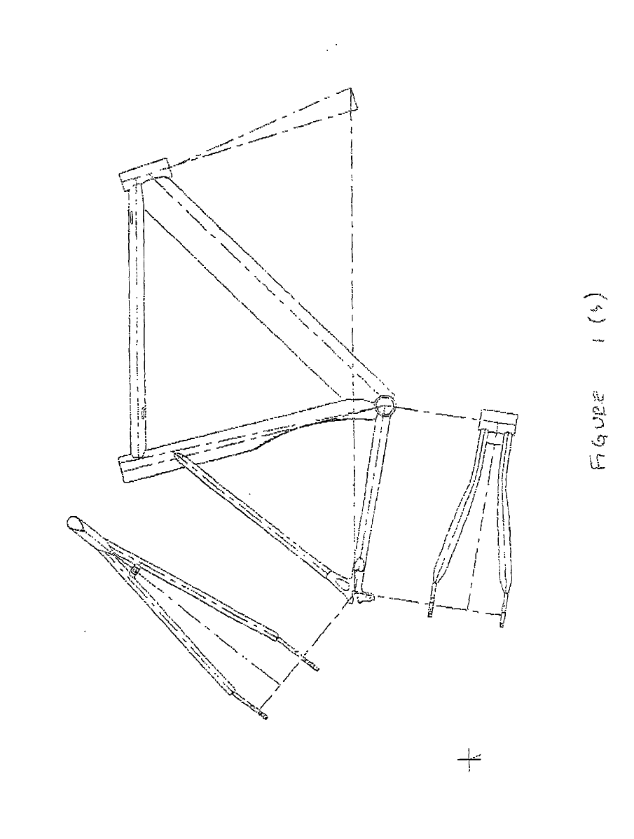

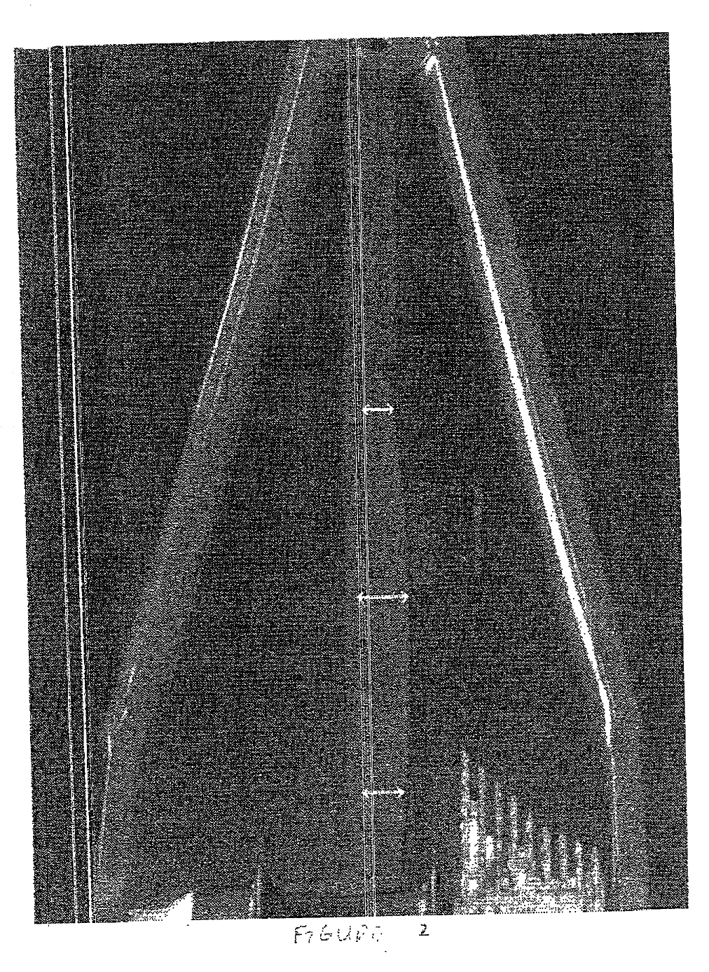

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

The invention comprises a frame having parts which are analogous to a typical bicycle; i.e. the invention comprises a head tube 1 to which is attached a top tube 2 and a down tube 3. A seat tube 4 connects the ends of the top tube and the down tube.

The seat tube 4 in the present invention possesses an exaggerated curvature 5, seen in FIGS. 6 and 7, below the seat post-seat tube junction 6. This curvature terminates at the seat tube-down tube junction 7.

The rear wheel of the bicycle is mounted on its axle such that the tread of the tire is in extremely close proximity to the trailing edge of the curvature of the seat tube, or recessed into it, as seen in FIG. 14.

However, it should be noted that the principal part of this invention is the curved seat tube with its enhanced aerodynamics shielding of the rear wheel. As such, the bicycle frame may be of other forms that may not incorporate all of the traditional bicycle frame tubes as shown in the figures. For example, the nature of the invention would not be compromised if the top tube, or seat stays, or chainstays were deleted.

In addition to the principal invention, the following inventions support the principal invention:

1. The integration of the seat stays with the seat tube which results in a much cleaner aerodynamic form.

2. The brake plate to which the rear brake must be attached before the plate (with the attached brake) are then bolted to the frame. This design allows us to attach the brake to the frame in its conventional orientation while enhancing the aerodynamics, stiffness, or strength of the area. (see FIG. 5).

3. The portion of the seat tube forward of the rear wheel has a trailing edge of constant width which protects the rear wheel by the same amount over its complete length.

4. The long length and high curvature of the lower curved portion of the seat tube protects and covers the forward edge of more of the rear wheel than is possible with prior art designs.

5. The high curvature and long length of the lower curved section of the seat tube results in improved rider comfort compared to prior art designs.

6. The use of horizontal dropouts to optimize the tire clearance to the curved seat tube for use with different tire and wheel sizes.

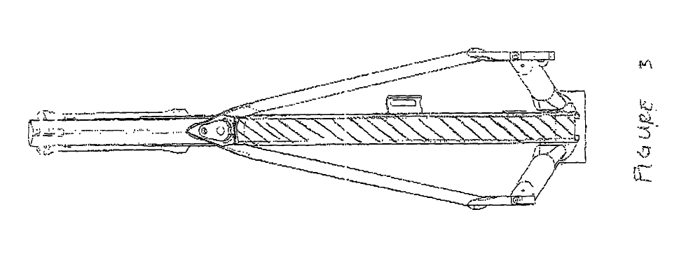

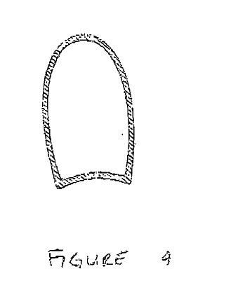

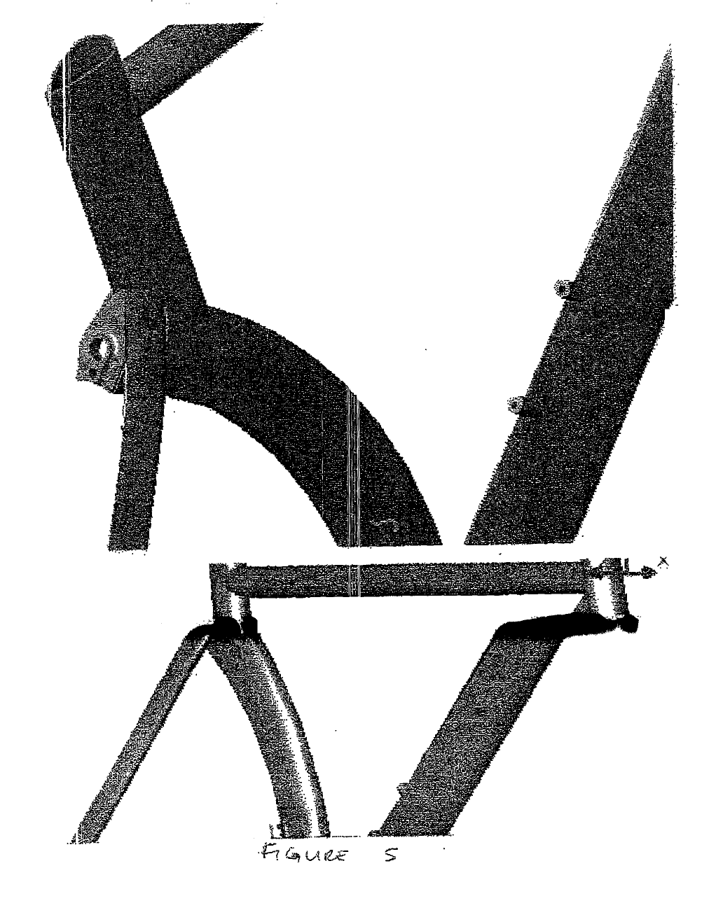

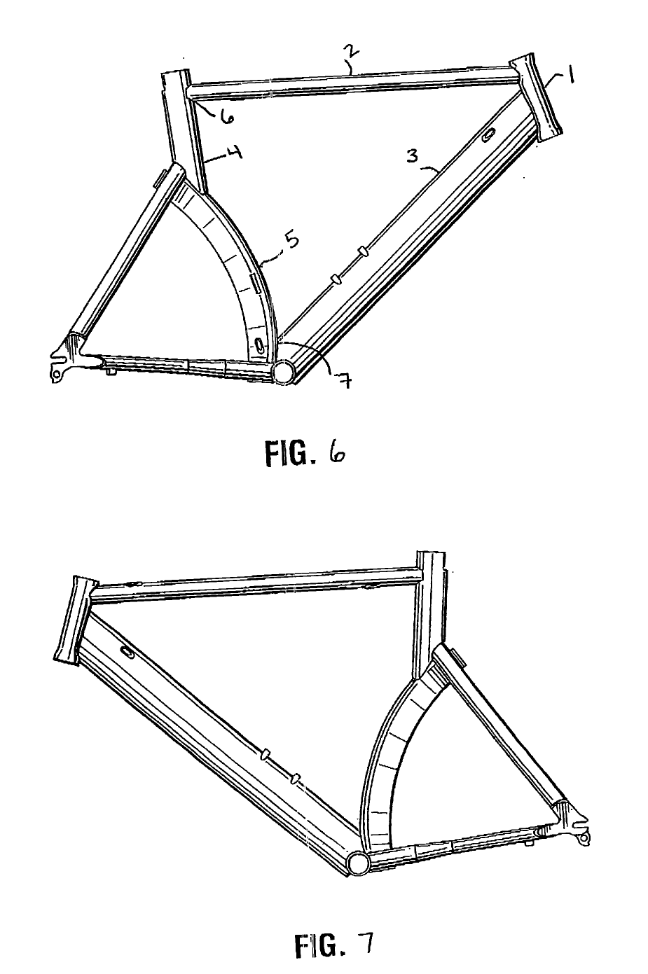

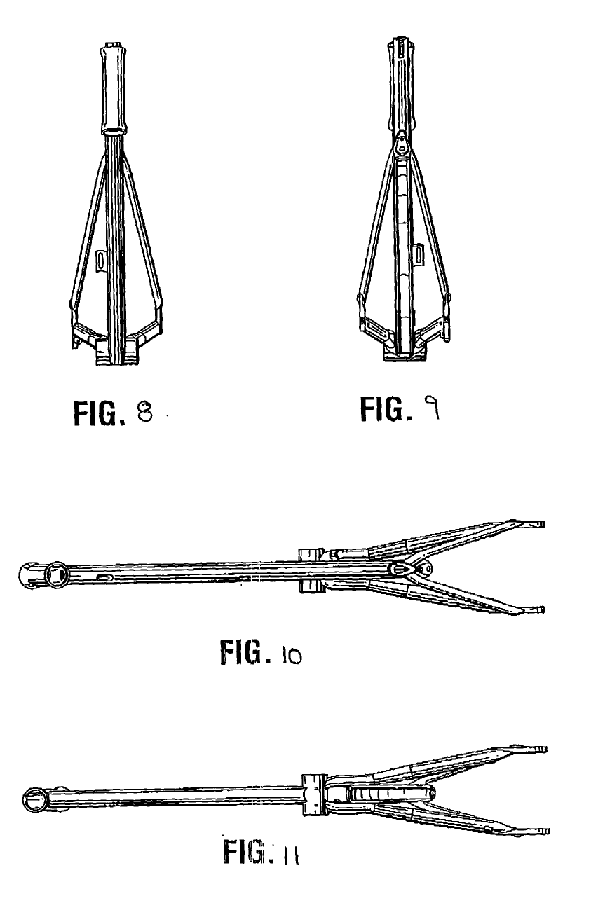

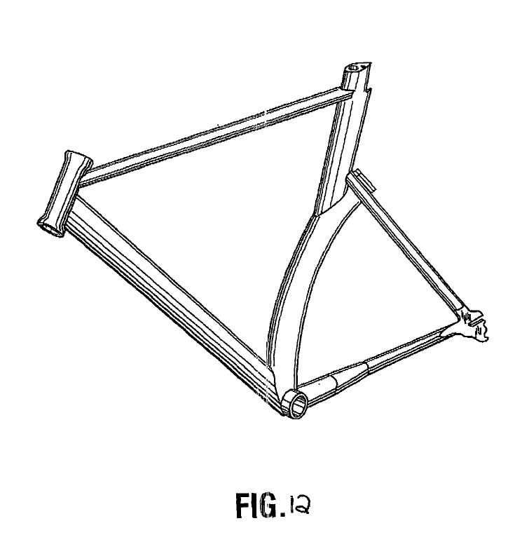

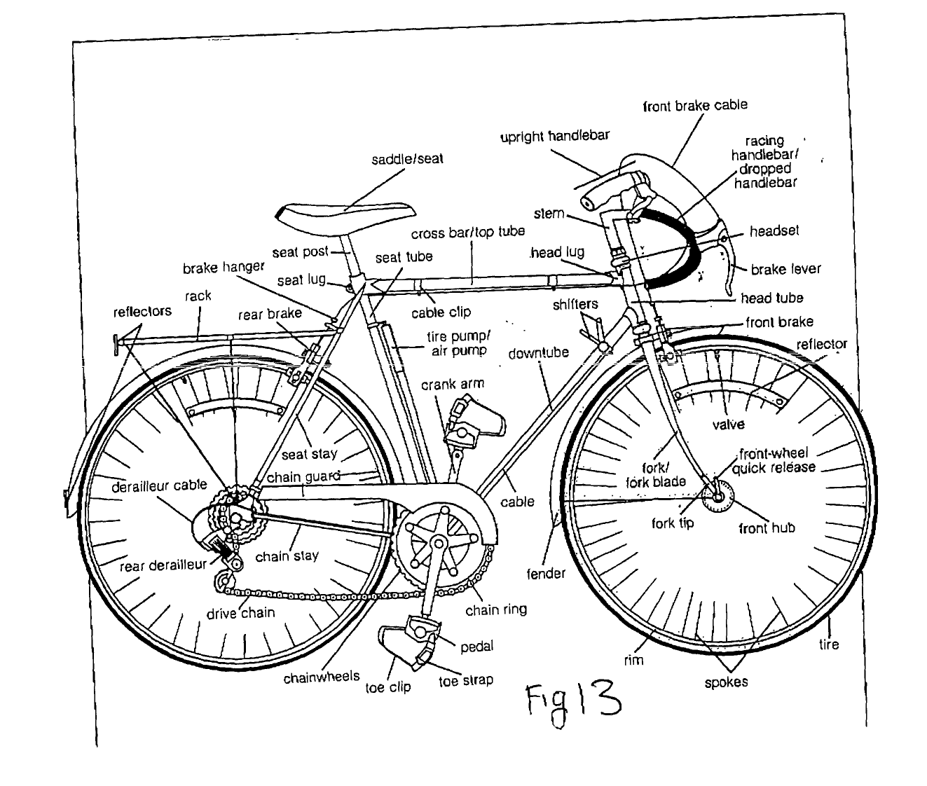

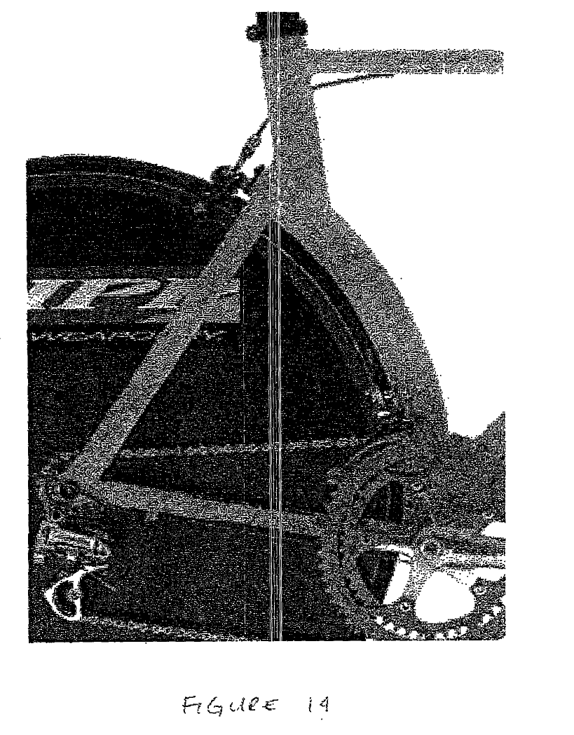

7. A recessed concave area in the rear of the seat tube to further enhance the rear wheel aerodynamics. Seat tube lower cross section is shaped as shown in FIG. 4.

8. The design of the seat tube also has the additional advantage of moving the Aerodynamic Center of Pressure to the rear which further enhances stability.

Thus, it is apparent that there has been provided in accordance with the invention an AERODYNAMIC BICYCLE FRAME that fully satisfies the objects, aims and advantages set forth above. While the invention has been described in conjunction with a specific embodiment hereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What we claim as our invention:

1. An arrangement of a bicycle frame and wheel wherein a seat tube portion of said frame facing said wheel is curved to conform to the curvature of the wheel.

2. An arrangement of a bicycle frame wherein the rear wheel is positioned such that the tread of the tire is in close proximity to the trailing edge of the curvature in the seat tube of claim 1.
